(19) United States
(12) Patent Application Publication
(10) Pub. No.: US 2013/0016157 A1
(43) Pub. Date: Jan. 17, 2013

(54) INKJET PRINTING HEAD PROTECTION AND STORAGE MEDIUM

(71) Applicant: Fatih Mehmet Akici, Istanbul (TR)

(72) Inventor: Fatih Mehmet Akici, Istanbul (TR)

(21) Appl. No.: 13/511,108

(22) PCT Filed: Nov. 20, 2009
(86) PCT No.: PCT/EP2009/065590

§ 371 Date: Oct. 1, 2012

(51) Int. Cl. B41J 2/165

(52) U.S. Cl. 347/29

(57) ABSTRACT

The present invention proposes a multi-layered sealing medium having a sealing pad with high performance mechanical energy damping characteristics, a double-side adhesive character intermediary layer and a PVC film coated with a pressure sensitive acrylic-based adhesive. Said PVC film provides a stable adhesion strength behavior on a nozzle unit in function of time together with high performance deformation behavior offering an easy removal and an improved chemical resistance against inks. Said multi-layered sealing medium further comprises a one-sided siliconised polyester liner for protecting said PVC film prior to applying to the nozzle plate of a printing head.

### TECHNICAL FIELD OF THE INVENTION

The invention relates to an inkjet cartridge printing device seal within a container body for receiving refilled, shipped, stored cartridges.

### BACKGROUND OF THE INVENTION

In accordance with the present invention, it is provided an inkjet cartridge printing head seal comprising a plurality of layers with an elastomeric seal pad and protective layers including a double-side adhesive layer. Said sealing medium therefore holds the inkjet cartridge printing head nozzle plate air-tight when shipped or stored.

Inkjet printers are used all over the world on a very extensive scale. Such printers utilize ink filled cartridges. Printing is conventionally implemented by ejecting ink through nozzles upon paper or other media forming images.

When an inkjet cartridge is stored or shipped, ink will dry plugging orifices in the nozzle plate unless an effective seal is applied. An effective seal accommodating a variety of inkjet cartridges preventing ink drying would be beneficial.

### OBJECTS OF THE INVENTION

One of the objects of the present invention is to provide an inkjet cartridge printing head seal whose use will provide an air tight nozzle plate seal.

Another object of the present invention is to provide an inkjet cartridge printing head seal which will prevent color cartridge cross contamination.

Another object of the present invention is to provide an inkjet cartridge printing head seal whose use allows inkjet cartridges to be shipped or stored without ink leaking or drying such that impacts to the extent that the air-tightness of the nozzle plates is jeopardized during transport and storage are absorbed.

### SUMMARY OF THE INVENTION

The present invention proposes a multi-layered sealing medium having a sealing pad with high performance mechanical energy damping characteristics, a double-side adhesive character intermediary layer and a PVC film coated with a pressure sensitive acrylic-based adhesive. Said PVC film provides a stable adhesion strength behavior on a nozzle unit in function of time together with high performance deformation behavior offering an easy removal and an improved chemical resistance against inks. Said multi-layered sealing medium further comprises a one-sided siliconised polyester liner for protecting said PVC film prior to applying to the nozzle plate of a printing head.

In particular, an inkjet cartridge printing head protective sealing medium comprising a sealing pad made of polyurethane and having a density of 200 to 300 kg/m³, a tensile strength of 510 to 660 kPa and a tear strength of 1.0 to 1.8 kN/m is disclosed. The sealing medium further comprises a double-side adhesive character intermediary layer and a PVC film coated with an adhesive. The PVC film has a tensile strength (MD) of 10 N/10 mm to 40 N/10 mm and an elongation (MD) of at least 150%.

In addition to the sealing medium, a container body receiving a printer cartridge in the manner that the nozzle plate of said cartridge is maintained on said multi-layered sealing medium is also disclosed. The multi-layered sealing medium is secured on the container body.

### BRIEF DESCRIPTION OF THE FIGURES

Accompanying drawing is given solely for the purpose of exemplifying an inkjet cartridge printing head seal whose advantages over prior art were outlined above and will be explained in detail hereinafter:

FIG. 1a is an exploded perspective view of the layers of the sealing member with the elastic pad and three protective layers,

FIG. 1b is an exploded perspective view of the layers of the sealing member with the elastic pad and three protective layers bent over,

FIG. 2a is an exploded perspective view of the layers of the sealing member with the elastic pad and two protective layers,

FIG. 2b is an exploded perspective view of the layers of the sealing member with the elastic pad and two protective layers bent over,

FIG. 3 is a schematic perspective view of the elastic pad of the sealing member,

FIG. 4a is a schematic perspective view of a container body for holding an ink cartridge,

FIG. 4b is a schematic perspective view of a container body for holding an ink cartridge,

FIG. 4c is a side view of a container body for holding an ink cartridge,

FIG. 5a is a schematic perspective view of a container body for holding an ink cartridge,

FIG. 5b is a schematic perspective view of a container body for holding an ink cartridge,

FIG. 5c is a side view of a container body for holding an ink cartridge,

FIG. 6a is a schematic perspective view of a container body for holding an ink cartridge,

FIG. 6b is a schematic perspective view of a container body for holding an ink cartridge,

FIG. 6c is a side view of a container body for holding an ink cartridge,

FIG. 7a is a schematic perspective view of a container body for holding an ink cartridge,

FIG. 7b is a schematic perspective view of a container body for holding an ink cartridge,

FIG. 7c is a side view of a container body for holding an ink cartridge,

FIG. 8a is a schematic perspective view of a container body for holding an ink cartridge,

FIG. 8b is a schematic perspective view of a container body for holding an ink cartridge,

FIG. 8c is a side view of a container body for holding an ink cartridge,

FIG. 9a is a schematic perspective view of a container body for holding an ink cartridge,

FIG. 9b is a schematic perspective view of a container body for holding an ink cartridge,

FIG. 9c is a side view of a container body for holding an ink cartridge,

FIG. 10 is a photograph obtained from a microscope and showing a very thin fiber from a paper tissue blocking an injection nozzle of an ink cartridge

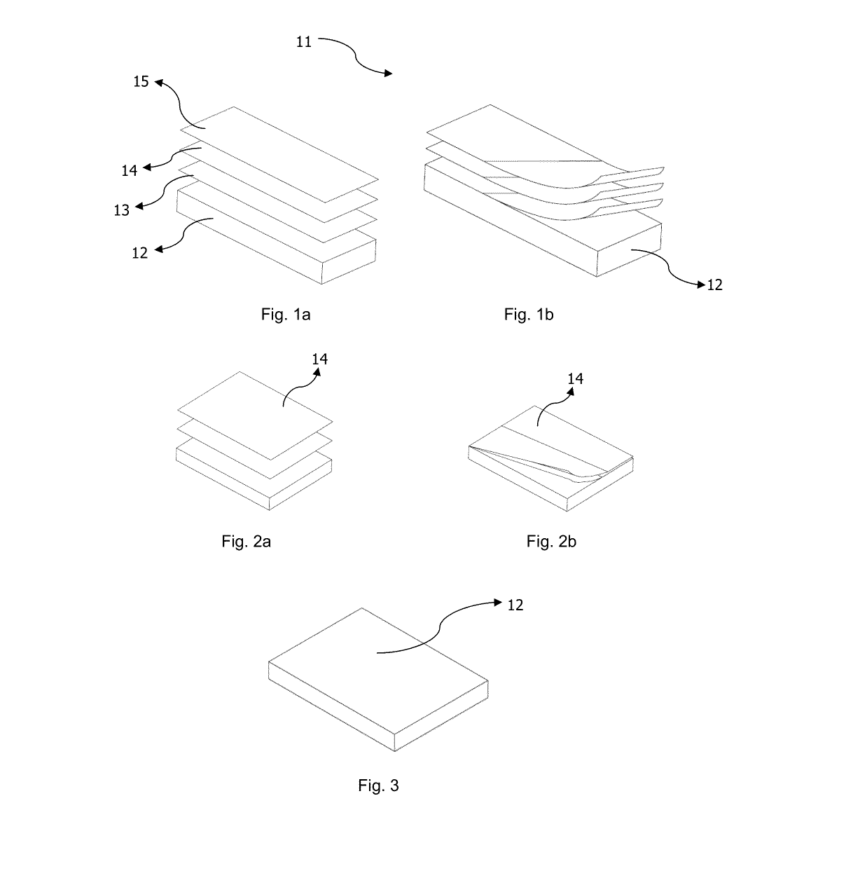

### DETAILED DESCRIPTION OF THE INVENTION

According to the present invention, a multi-layered sealing medium (11) having a sealing pad (12) with high performance mechanical energy damping characteristics is provided. Said sealing pad (12) being made of polyurethane, preferably has a density of 200 to 300 kg/m³. It has most preferably a density of 240 kg/m³.

The sealing pad (12) according to the present invention is classified as a high density material as high density polyurethane is characterized by a density range of 50 kg/m3 to about 1000 kg/m³.

Said sealing pad (12) preferably has a tensile strength of 510 to 660 kPa and most preferably 570 to 600 kPa. The tear strength of the same is preferably 1.0 to 1.8 kN/m and most preferably 1.2 to 1.6 kN/m. On the other hand, corrosion resistance of said sealing pad (12) requires to be classified as excellent as measured according to ASTM D3568. Normal operating temperature range is 40° C. to 107° C.

Said sealing pad (12) being suitable for die cutting, is used in various dimensions to cover required nozzle area. It features a compression set of 40 to 60% and preferably 50%. As is known to the person in the art, the compression set being defined as the percentage by which a sample fails to return to its original thickness after being subjected to a standard compressive load or deflection for a fixed period of time. The deflection is measured as 0.19% according to ASTM D1667 (22 hours at 23° C.) and 3.0% according to ASTM D3574 (22 hours at 70° C.).

Said multi-layered sealing medium (11) further comprises a double-side adhesive character intermediary layer (13) having an operating temperature range of 100° C. to 200° C.

Said multi-layered sealing medium (11) further comprises a PVC film (14) coated with a pressure sensitive acrylic-based adhesive. Said PVC film (14) is bonded to said sealing pad (12) by means of said double-side adhesive character layer (13). Said PVC film (14) shows an improved deformation capacity due to its mechanical properties, i.e. a tensile strength (MD) of 25 N/10 mm and an elongation (MD) 250%. On the other hand, the required mechanical effect of the PVC film (14) can be obtained with a tensile strength (MD) of 10 N/10 mm to 40 N/10 mm and an elongation (MD) of at least 150%. Said PVC film (14) therefore shows an improved deformation performance against pressure.

The air-tight character of the sealing medium (11) is achieved by said PVC film (14) being coated with said pressure sensitive adhesive. The surface tension required to achieve the adhesive force is effected by the PVC film (14) having an adhesion to BA steel value of 80 to 120 cN/20 mm and preferably 100 cN/20 mm.

Said multi-layered sealing medium (11) further comprises a one-sided siliconised polyester liner for protecting said PVC film (14) prior to application to the nozzle plate of a printing head. Therefore said liner (15) is only removed to allow application of said pressure sensitive adhesive coated PVC film (14) to the nozzle plate.

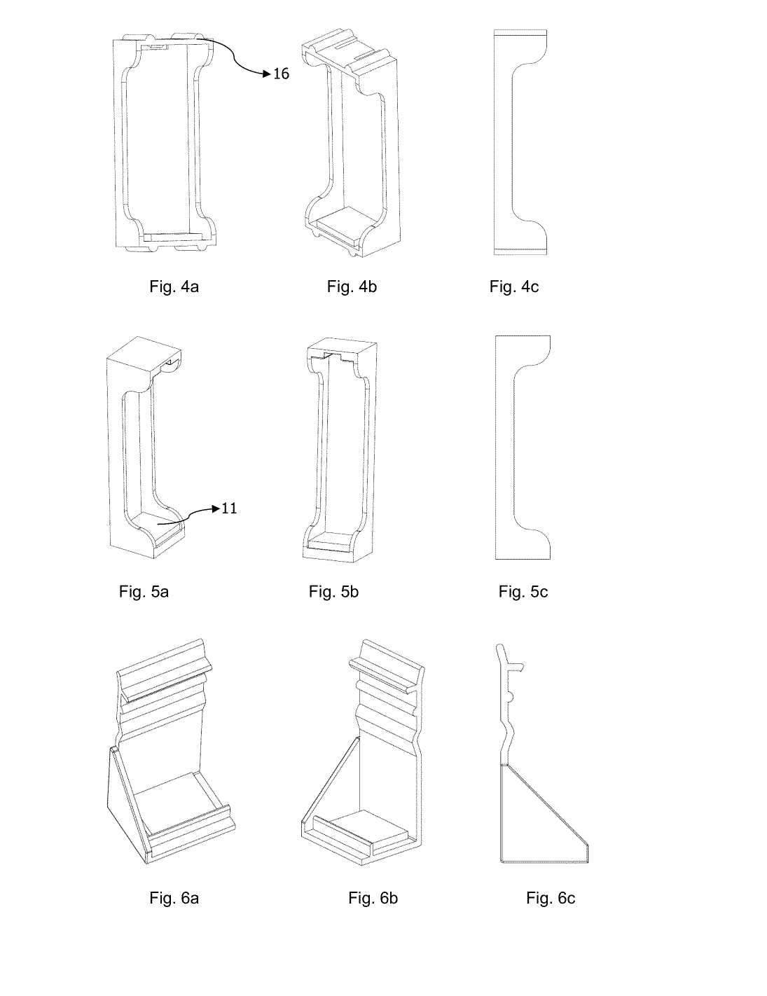

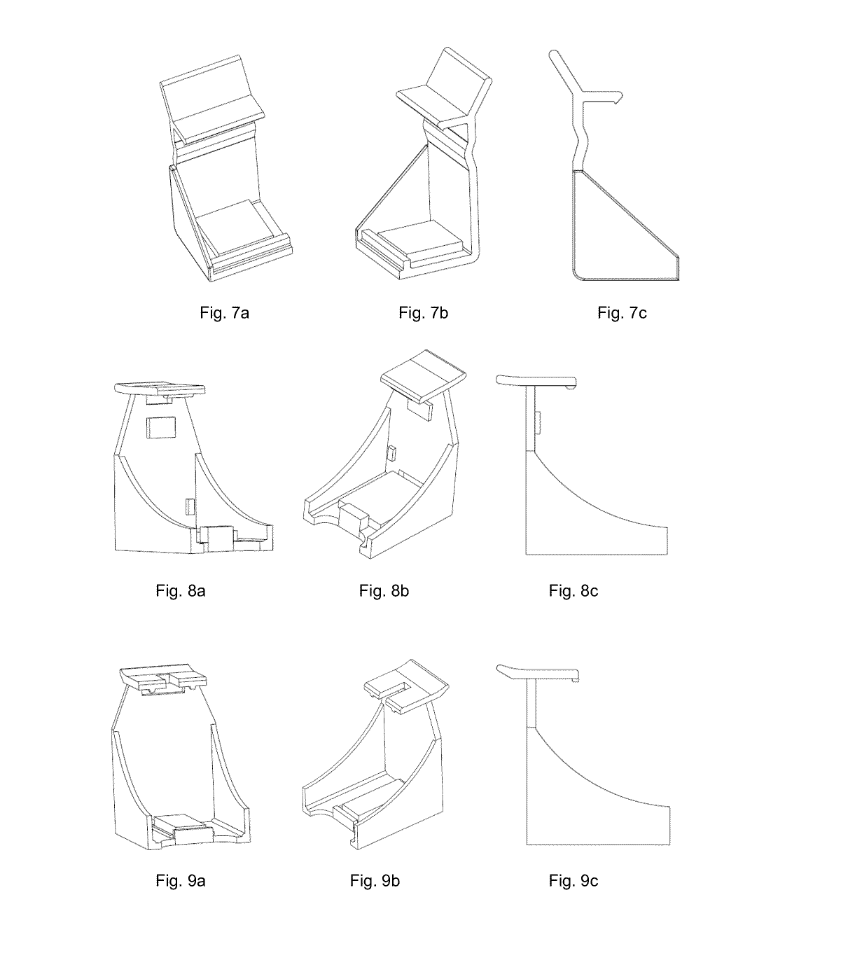

FIGS. 4 to 9 demonstrate various container bodies (16) for receiving a printer cartridge in the manner that the nozzle plate of the cartridge is maintained on said multi-layered sealing medium (11).

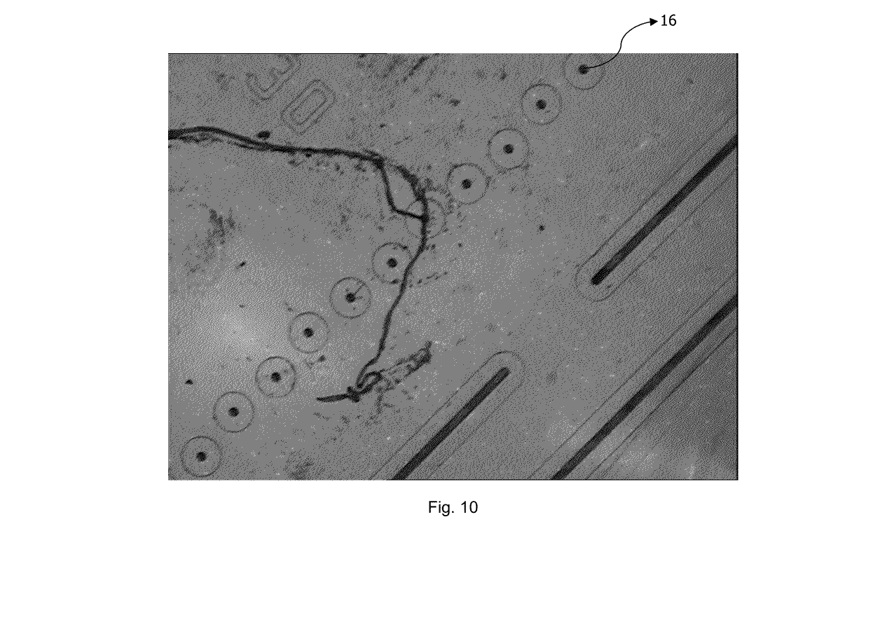

FIG. 10 demonstrates a plurality of micron-level nozzles on a certain portion of a nozzle plate. A given cartridge duly passed all quality tests after manufacture (or refill) prior to delivery to customers may afterwards have nozzles that are already blocked by tiny particles present in the air or by any other substance such as the cellulose-based micron-level fiber shown in FIG. 10 blocking a nozzle orifice (17). Therefore, the solution of the present invention as defined in claim 1 provides protection of a duly manufactured cartridge such that no contamination of ink or adherence of air-borne particles is possible as an air-tight surface covering is applied.

Further, the multi-layered sealing medium (11) of claim 1 is effective in absorbing impacts to the extent that the air-tightness of the nozzle plates can not be jeopardized during transport and storage.

Said multi-layered sealing medium's (11) outermost surface, namely said PVC film (14) being coated with a pressure sensitive adhesive provides both improved surface tension and improved deformation performance against pressure

In a nutshell, the present invention provides an inkjet cartridge printing head protective sealing medium (11) comprising a sealing pad made of polyurethane and having a density of 200 to 300 kg/m³, a tensile strength of 510 to 660 kPa and a tear strength of 1.0 to 1.8 kN/m. Said sealing medium (11) further comprises a double-side adhesive character intermediary layer (13) and a PVC film (14) coated with an adhesive. Said PVC film (14) has a tensile strength (MD) of 10 N/10 mm to 40 N/10 mm and an elongation (MD) of at least 150%.

1. An inkjet cartridge printing head protective sealing medium (11) comprising a sealing pad (12) made of polyurethane and having a density of 200 to 300 kg/m³, a tensile strength of 510 to 660 kPa and a tear strength of 1.0 to 1.8 kN/m, said sealing medium (11) further comprising a double-side adhesive character intermediary layer (13) and a PVC film (14) coated with an adhesive, said PVC film (14) having a tensile strength (MD) of 10 N/10 mm to 40 N/10 mm and an elongation (MD) of at least 150%.

2. An inkjet cartridge printing head protective sealing medium (11) according to claim 1 wherein said sealing pad (12) has a tensile strength of 570 to 600 kPa and a tear strength of 1.2 to 1.6 kN/m.

3. An inkjet cartridge printing head protective sealing medium (11) according to claim 2 wherein said sealing pad (12) has a tensile strength of 586 kPa and a tear strength of 1.4 kN/m.

4. An inkjet cartridge printing head protective sealing medium (11) according to claims 1 to 3 wherein said PVC film (14) has a tensile strength (MD) of 25 N/10 mm and an elongation (MD) 250%.

5. An inkjet cartridge printing head protective sealing medium (11) according to claim 1 or 4 wherein said sealing pad (12) features a compression set of 40 to 60%.

6. An inkjet cartridge printing head protective sealing medium (11) according to claim 5 wherein said sealing pad (12) features a compression set of 50%.

7. An inkjet cartridge printing head protective sealing medium (11) according to any of the previous Claims wherein corrosion resistance of said sealing pad (12) is classified high according to ASTM D3568.

8. An inkjet cartridge printing head protective sealing medium (11) according to any of the claims 1 to 7 wherein said adhesive coated on said PVC film (14) is a pressure sensitive acrylic-based adhesive having an adhesion to BA steel value of 80 to 120 cN/20 mm.

9. An inkjet cartridge printing head protective sealing medium (11) according to claim 8 wherein said pressure sensitive acrylic-based adhesive has an adhesion to BA steel value of 100 cN/20 mm.

10. An inkjet cartridge printing head protective sealing medium (11) according to any previous Claim wherein said sealing medium (11) further comprises a liner (15) applied on said adhesive coated PVC film (12).

11. A container body (16) receiving a printer cartridge in the manner that the nozzle plate of said cartridge is maintained on said multi-layered sealing medium (11) of claims 1 to 9, said multi-layered sealing medium (11) being secured on said container body (16).
